(19) United States
(12) Patent Application Publication
(10) Pub. No.: US 2007/0179917 A1
(43) Pub. Date: Aug. 2, 2007

(54) Intelligent design optimization method and system

(75) Inventors: Amar Patel, Urbana, IL (US); William K. Rutan, Chillicothe, IL (US); Robert M. McDavid, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/342,635

(22) Filed: Jan. 31, 2006

(51) Int. Cl. G06N 3/12

(52) U.S. Cl. 706/13

(57) ABSTRACT

A method is provided for a computer based design system. The method may include selecting a first plurality of sets of design parameters of a design model representing a design application and individually simulating the design model for each set of the first plurality of sets of the design parameters to create a respective plurality of sets of output parameters corresponding to the design parameters. The method may also include choosing at least one set of the design parameters with a corresponding set of output parameters that satisfy predetermined criteria and selecting a second plurality of sets of the design parameters based on the at least one set of the design parameters.

### TECHNICAL FIELD

This discosure relates generally to computer based artificial intelligence techniques and, more particularly, to methods and systems for optimizing designs using genetic algorithms and neural networks.

### BACKGROUND

Computer based design methodologies may be used in many industries to facilitate engineering design applications. These design methodologies often use various processes or design models to model complex systems under design, such as internal combustion engines, communication networks, buildings, airplanes, and/or power plant, etc. For example, an engine design may include computer models for engine combustion chambers, engine combustion and emission, fuel injection and mixing, intake and exhaust ports, and/or engine cooling system, etc. Complicated mathematical calculations may be often required to build these models.

The various process or design models may be simulated by using a large number of data sets of operating parameters and design parameters to derive corresponding output parameters. Optimization methods may be used to find optimum or desired design parameters corresponding to desired output parameters. The optimization of design models may be carried out by various techniques and may often involve many iterations of simulation. For example, U.S. Pat. No. 5,666,297 issued to Britt et al. on Sep. 9, 1997, discloses a dual execution mode software system for simulating and optimizing a processing plant design.

However, these conventional techniques often do not guide the optimization process to reach a globally optimum solution within a desired period of time. Further, when the underlying computer model itself is complex, a single iteration of simulation of the model may cause a large amount of computation and thus may take a long period of time to complete. When the optimization process may use numerous iterations of simulation, it may also be computationally impractical to complete the entire optimization process in a reasonable amount of time.

Methods and systems consistent with certain features of the disclosed systems are directed to solving one or more of the problems set forth above.

### SUMMARY OF THE INVENTION

One aspect of the present disclosure includes a method for a computer based design system. The method may include selecting a first plurality of sets of design parameters of a design model representing a design application and individually simulating the design model for each set of the first plurality of sets of the design parameters to create a respective plurality of sets of output parameters corresponding to the design parameters. The method may also include choosing at least one set of the design parameters with a corresponding set of output parameters that satisfy predetermined criteria and selecting a second plurality of sets of the design parameters based on the at least one set of the design parameters.

Another aspect of the present disclosure includes a method for a computer-based design system. The method may include creating a current generation of design parameters of a design model and simulating the design model by using the current generation of design parameters via a first genetic algorithm to generate a first set of desired design parameters. The method may also include establishing a process model based on the design model and simulating the process model by using the current generation of design parameters via a second genetic algorithm to generate a second set of desired design parameters. Further, the method may include selecting a next generation of design parameters based on the first set of desired design parameters and the second set of desired design parameters.

Another aspect of the present disclosure includes a computer system. The computer system may include a database containing data records associating a design application represented by a design model and a processor. The processor may be configured to create a current generation of design parameters of the design model and to simulate the design model by using the current generation of design parameters via a first genetic algorithm to generate a first set of desired design parameters. The processor may also be configured to establish a process model based on the design model; to simulate the process model by using the current generation of design parameters via a second genetic algorithm to generate a second set of desired design parameters; and to select a next generation of design parameters based on the first set of desired design parameters and the second set of desired design parameters.

Another aspect of the present disclosure includes a computer-readable medium for use on a computer system configured to perform a design optimization procedure. The computer-readable medium may include computer-executable instructions for performing a method. The method may include creating a current generation of design parameters of a design model and simulating the design model by using the current generation of design parameters via a first genetic algorithm to generate a first set of desired design parameters. The method may also include establishing a process model based on the design model and simulating the process model by using the current generation of design parameters via a second genetic algorithm to generate a second set of desired design parameters. The method may further include selecting a next generation of design parameters based on the first set of desired design parameters and the second set of desired design parameters.

### BRIEF DESCRIPTION OF THE DRAWINGS

FIG. 1 illustrates a block diagram of an exemplary design optimization environment consistent with certain disclosed embodiments;

illustrates a block diagram of a computer system consistent with certain disclosed embodiments;

FIG. 3 illustrates a flowchart of an exemplary single track optimization process;

FIG. 4 illustrates a flowchart of an exemplary secondary optimization process consistent with certain disclosed embodiments; and

FIG. 5 illustrates a flowchart of an exemplary retraining process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

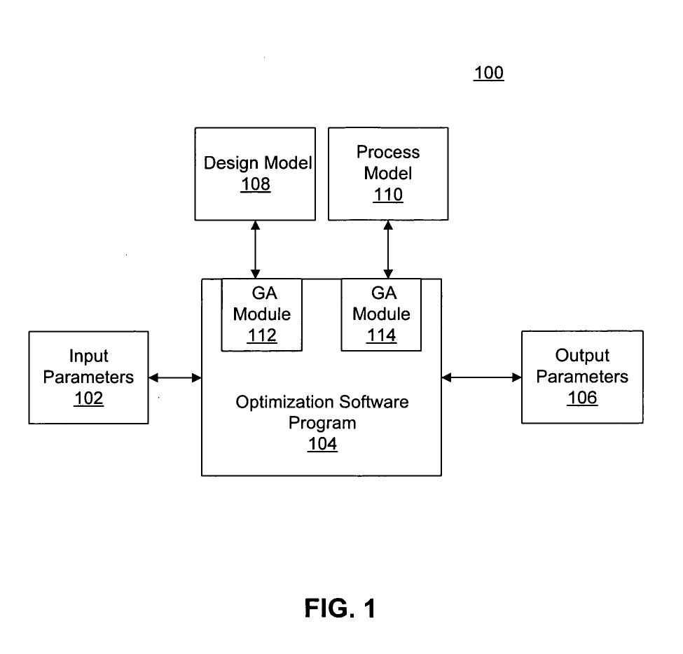

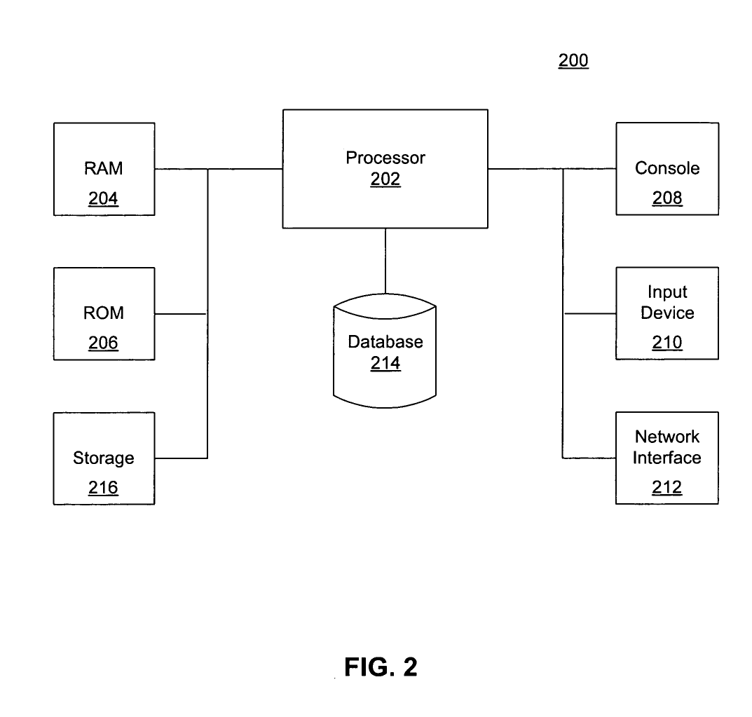

FIG. 1 illustrates a block diagram of an exemplary design optimization environment 100. As shown in FIG. 1, an optimization software program 104 may be used as a software controller to control and coordinate interactions between input parameters 102, output parameters 106, design model 108, and process model 110. Input parameters 102 may include any appropriate type of data associated with a particular design application. For example, in an engine design application, input parameters 102 may include various designs and/or operating parameters of an engine, such as engine combustion parameters, main combustion chamber and prechamber parameters (e.g., shape, surface, and/or size of pistons, etc.), engine block and cylinder head cooling passage design parameters, intake and exhaust port design parameters, fuel injection and mixing parameters (e.g., fuel injection rate and timing, etc.), etc.

Output parameters 106, on the other hand, may include any appropriate type of output parameters of the particular design application corresponding to input parameters 102. For instance, in the engine design example, output parameters 106 may include output power of the engine and/or emission parameters, such as Nitrogen Oxides (NOₓ), Sulfur Dioxide (SO₂), Carbon Monoxide (CO), total reduced Sulfur (TRS), etc. In particular, NOₓ emission sensing and reduction may be important to normal operation of the engine. Other output parameters, however, may also be used.

Design model 108 may include any appropriate mathematical models for modeling a particular design application. For example, design model 108 may include various mathematical/thermodynamical models to model an engine. Design model 108 may be simulated based on input parameters 102 to generate output parameters 106. That is, design model 108 may be provided with input parameters 102 (e.g., piston bowl shape, fuel injection rate and start of injection timing, etc.) and may generate output parameters 106 corresponding to input parameters 102 (e.g., power, emission levels, etc.). In certain embodiments, design model 108 may be established by using computational fluid dynamics (CFD) models. Other mathematical models, such as linear system models, and/or non-linear system models, etc., may also be used.

Optimization software program 104 may also include artificial intelligence algorithms to optimize the design application. That is, optimization software program 104 may use artificial intelligence algorithms to find a desired set of values of design parameters of input parameters 102 (i.e., optimized design parameters) such that design model 108 may generate desired values of output parameters 106. For example, optimization software program 104 may find a desired set of values of engine design parameters (e.g., piston bowl shapes, fuel injection rate and start of injection timing, etc.) such that design model 108 generates desired engine power with emission levels under a predetermined threshold. The emission levels may include levels of various emission substances, such as NOₓ.

The optimization process may be implemented as a searching process to search the valid input space of input parameters 102 to find a desired set of values of input parameters 102 that result in desired values of output parameters 106. Input space may refer to entire ranges of valid values of input parameters 102. In certain embodiments, genetic algorithms (GA) may be used by optimization software program 104 to carry out the optimization process or the searching process. Other algorithms, such as fuzzy logic algorithms, may also be used.

Optimization software program 104 may include a GA module 112 and a GA module 114. GA module 112 may include a first genetic algorithm and may be used to find optimized design parameters based on simulations of design model 108. On the other hand, GA module 114 may include a second genetic algorithm and may be used to find optimized design parameters based on simulation of process model 110. GA module 112 and GA module 114 may use same search spaces and/or same searching ranges during the optimization process. A search space may refer to a certain range of valid values of input parameters 102. A search space may cover the entire range of values of input parameters 102 (i.e., input space) or a subset range of values of input parameters 102.

Process model 110 may be a process model established based on design model 108. That is, process model 110 may be a mathematical model indicative of interrelationships between input parameters 102 and output parameters 106 that are created and/or represented by design model 108. Process model 110 may include any appropriate type of mathematical or physical model indicating the interrelationships between input parameters 102 and output parameters 106 of design model 108. For example, process model 110 may include a neural network based mathematical model that is trained to represent interrelationships between input parameters 102 and output parameters 106 as indicated in design model 108. Other types of mathematical models, however, may also be used.

Process model 110 may be established and trained by using training data. Training data may include any appropriate data records of both input parameters 102 and output parameters 106 based on design model 108. In certain embodiments, process model 110 may be trained based on simulation results of design model 108. For example, after a certain number of iterations of simulations of design model 108, resulting data records containing values of input parameters 102 and corresponding values of output parameters 106 may be used to establish and/or train process model 110.

After process model 110 is trained, process model 110 may be simulated independently to optimize the design parameters (i.e., to find desired design parameters). Because process model 110 may use a different modeling method from design model 108 (e.g., process model 110 may use neural network models instead of CFD models that may be used by design model 108), the simulation of process model 110 may take less time compared to the simulation of design model 108. Process model 110 may be used to reduce the search space and/or searching time of design model 108 during the optimization process.

The optimization process and optimization software program 104 may be implemented by one or more computer systems. FIG. 2 shows a functional block diagram of an exemplary computer system 200 that may be used to perform these optimization processes and operations.

As shown in FIG. 2, computer system 200 may include a processor 202, a random access memory (RAM) 204, a read-only memory (ROM) 206, a console 208, an input device 210, a network interface 212, a database 214, and a storage 216. It is understood that the type and number of listed devices are exemplary only and not intended to be limiting. The number of listed devices may be changed and other devices may be added.

Processor 202 may include any appropriate type of general purpose microprocessor, digital signal processor, or microcontroller. Processor 202 may execute sequences of computer program instructions to perform various processes as explained above. Processor 202 may be coupled to or access other devices, such as RAM 204, ROM 206, console 208, input device 210, network interface 212, database 214, and/or storage 216, to complete executions of computer program instructions. The computer program instructions may be loaded into RAM 204 for execution by processor 202 from read-only memory (ROM) 206, or from storage 216. Storage 216 may include any appropriate type of mass storage provided to store any type of information that processor 202 may need to perform the processes. For example, storage 216 may include one or more hard disk devices, optical disk devices, or other storage devices to provide storage space.

Console 208 may provide a graphic user interface (GUI) to display information to users of computer system 200. Console 208 may include any appropriate type of computer display device or computer monitor. Input device 210 may be provided for users to input information into computer system 200. Input device 210 may include a keyboard, a mouse, or other optical or wireless computer input device, etc. Further, network interface 212 may provide communication connections such that computer system 200 may be accessed remotely through computer networks via various communication protocols, such as transmission control protocol/internet protocol (TCP/IP), hyper text transfer protocol (HTTP), etc.

Database 214 may contain design parameters, model data and/or any information related to the design application. Database 214 may include any type of commercial or customized database. Database 214 may also include analysis tools for analyzing the information in the database. Processor 202 may also use database 214 to determine and store performance characteristics of optimization software program 104.

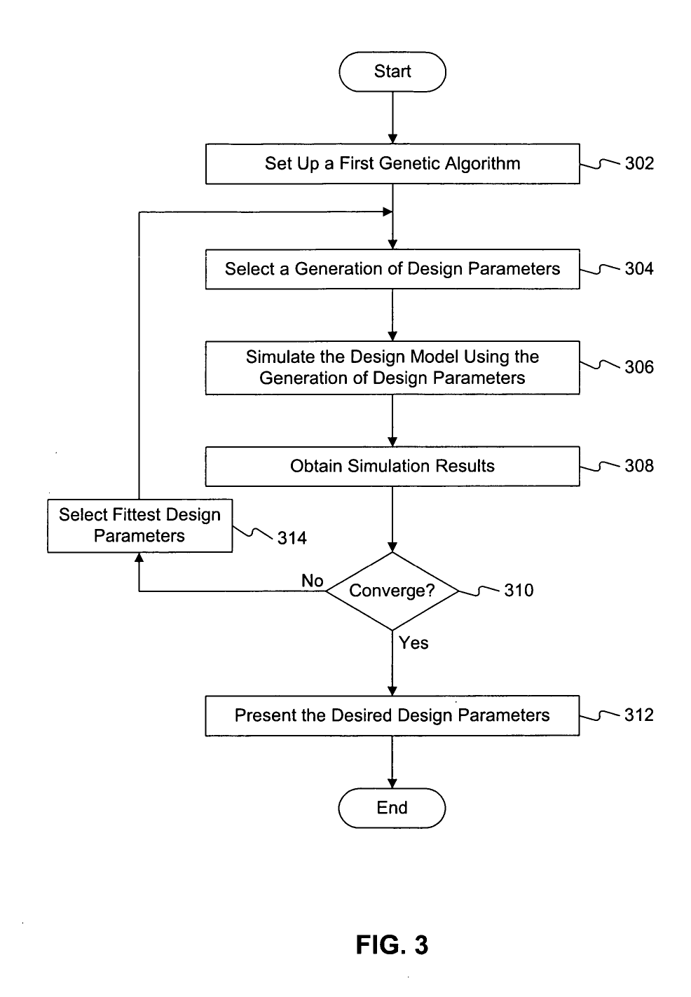

Processor 202 may execute optimization software program 104 to perform certain processes to optimize design parameters in the design application. FIG. 3 shows an exemplary single track optimization process performed by processor 202. In the single track optimization process, only design model 108 may be used for performing optimization of the design parameters.

As shown in FIG. 3, at the beginning of the process, processor 202 may set up a first genetic algorithm included in GA module 112 (step 302). The first genetic algorithm may include any appropriate type of genetic algorithm that may be used to find possible optimized solutions based on the principles of adopting evolutionary biology to computer science. When applying a genetic algorithm to search a desired subset of potential variables and/or a desired set of values of the variables, the variables may be represented by a list of parameters used to drive an evaluation procedure of the genetic algorithm. The parameter list may be called a chromosome or a genome, which may represent an encoding of all variables, either selected or unselected. For example, a “0” encoding of a variable may indicate that the variable is not selected, while a “1” encoding of a variable may indicate that the variable is selected. Chromosomes may also include genes, each of which may be an encoding of a value of an individual variable. Chromosomes and/or genes may be implemented as strings of data and/or instructions.

Initially, several such parameter lists or chromosomes and corresponding genes may be generated to create a generation. A generation may be a collection of a certain number of chromosomes and/or genes. The chromosomes and/or genes in the generation may be evaluated based on a fitness function, and a value of fitness may be returned by the fitness function. The generation may then be sorted, with those having better fitness ranked at the top as the fittest chromosomes and/or genes. Fitness may be evaluated based on the particular design application. In the engine design example, fitness may be evaluated based on levels of engine power and/or emission levels. Fitness function may be used to determine whether the engine power is beyond a predetermined level and/or to determine whether an emission level is below a predetermined threshold, based on simulation results of the models.

A second generation may be generated from the sorted initial generation by using any or all of the genetic operators, such as selection, crossover (or reproduction), and mutation. During selection, chromosomes and/or genes in the generation with fitness values below a predetermined threshold may be deleted. Selection methods, such as roulette wheel selection and/or tournament selection, may also be used.

After selection, reproduction operation may be performed upon the selected chromosomes and/or genes. Two selected chromosomes and/or genes may be crossed over along a randomly selected crossover point. Two new child chromosomes and/or genes may then be created and added to the generation. The reproduction operation may be continued until the generation size is restored.

Further, once the generation size is restored, mutation may be selectively performed on the generation. Mutation may be performed on a randomly selected chromosome by, for example, randomly altering bits in the chromosome data structure.

Selection, reproduction, and mutation may result in a second generation having chromosomes and/or genes that are different from the initial generation. The average degree of fitness may be increased by this procedure for the second generation, since better fitted chromosomes and/or genes from the first generation may be selected. This entire process may be repeated for any appropriate numbers of generations until the genetic algorithm converges. Each repeat may be referred to as an iteration of generation of simulation.

Convergence may be determined if the result of the genetic algorithm is improved during each generation and the rate of improvement reaches below a predetermined rate. Convergence may also be determined by the fitness function or if the value of a particular variable or variables reach a predetermined range. Other convergence determining methods, however, may also be used.

After setting up the first genetic algorithm included in GA module 112 (step 302), processor 202 may select a generation of design parameters (step 304). Processor 202, or a user of computer system 200 via processor 202, may also determine a searching space of the design parameters. That is, processor 202 may determine boundary constraints of design parameters for the particular design applications and/or certain design restrictions, such as maximum and minimum values of particular parameters. Processor 202 may select a certain number of sets of values of the design parameters (e.g., piston bowl shapes, fuel injection rate and start of injection timing, etc.) within the searching space. For example, processor 202 may select a family of 5 sets of design parameters to be included in the generation. Processor 202 may select the design parameters randomly or upon inputs from a user of computer system 200.

Processor 202 may simulate design model 108 using the design parameters included in the generation (step 306). For example, processor 202 may provide the design parameters to design model 108, one set at a time, to derive corresponding values of output parameters 106. After design model 108 finishes the simulations, processor 202 may obtain the resulting sets of values of output parameters 106 from design model 108 (step 308). Fitness of the resulting sets of values may also be calculated and ranked.

Processor 202 may determine, based on the sets of values of output parameters 106 and/or the fitness function, whether the first genetic algorithm converges (step 310). For example, processor 202 may determine that the first algorithm converges if the values of output parameters 106 (e.g., engine power, emission level, etc.) meet predetermined criteria (e.g., a desired engine power with a minimum emission level, etc.). If the first genetic algorithm converges (step 310; yes), processor 202 may determine that optimized design parameters are found. Processor 202 may also present the optimized design parameters to the user of computer system 200 or to other computer programs for further processing (step 312).

On the other hand, if the first genetic algorithm does not converge (step 310; no), processor 202 may select from the simulated sets of values of the design parameters a certain number (e.g., 1, 2, or more) of fittest design parameters (step 314). The fittest design parameters may refer to those design parameters that correspond to values of output parameters 106 that are closest to values that meet the convergence criteria.

After selecting the fittest design parameters (step 314), processor 202 may continue from step 304 to select a next generation of design parameters for simulation. Processor 202 may use various genetic algorithm techniques as explained above to select the next generation of design parameters based on the fittest design parameters from previous simulations. For example, processor 202 may perform crossover and/or mutation on the fittest design parameters to introduce variability and other desired effect to further reduce search spaces and to guide the optimization process. Processor 202 may continue the above steps until the genetic algorithm converges or until the process is stopped by the user of computer system 200 and/or other computer programs.

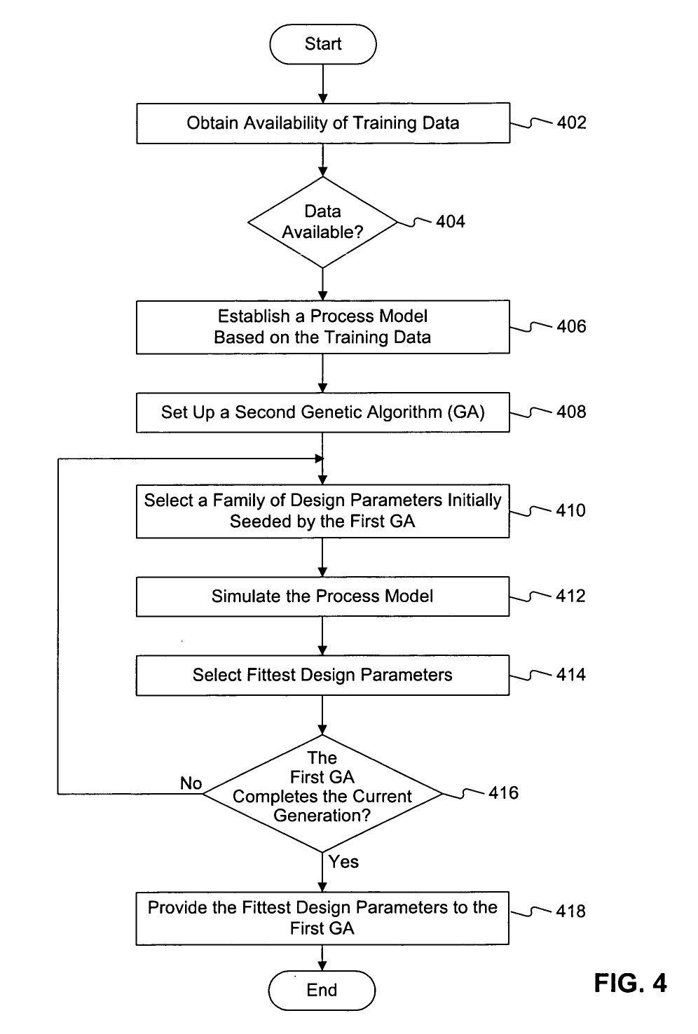

In certain embodiments, processor may also perform an enhanced optimization process that uses both design model 108 and process model 110. In the enhanced optimization process, processor 202 may perform a secondary optimization process using process model 110, and may combine the single track optimization process and the secondary optimization process. FIG. 4 shows an exemplary secondary optimization process performed by processor 202.

As shown in FIG. 4, the secondary optimization process may include a training phase and an operational phase. At the beginning of the process, or the training phase, processor 202 may obtain availability information of training data (step 402). For instance, processor 202 may obtain availability information from the single track optimization process, which may be performed independently from the secondary optimization process. After a certain number of generations of simulations, the single track optimization process may accumulate a certain amount of data records containing different values of design parameters and corresponding output parameters 106.

Processor 202 may further determine whether data records are available for training process model 108 (step 404). For example, if processor 202 determines that the accumulated data records may be sufficient to represent the interrelationships between input parameters 102 (e.g., the design parameters) and output parameters 106, processor 202 may decide that training data is available for training process model 108 (step 404; yes). In one embodiment, processor 202 may use the number of generations or iterations of simulation of design model 108 (e.g., 10 generations, etc.) as an indicator that training data is available.

On the other hand, if processor 202 decides that data records may be unavailable, either quantitatively or qualitatively, for training process model 108 (step 404; no), processor 202 may continue obtaining data availability information until data records are accumulated enough to be used for training purposes.

Once training data records are available (step 404; yes), processor 202 may establish process model 108 and train process model 108 using the available training data records (step 406). For example, processor 202 may use data records to train a neural network model indicating the interrelationships between the design parameters and output parameters 106. Any appropriate types of neural networks, such as feedback neural networks and feed-forward neural networks, etc., may be used.

After process model 110 is established and trained (i.e., training phase), processor 202 may begin an operational phase of the secondary optimization process. Processor 202 may set up a second genetic algorithm included in GA module 114 (step 408). Processor 202 may select a generation of design parameters to be simulated by process model 108 (step 410). To select an initial generation, processor 202 may wait for the first genetic algorithm to start a new generation and may select the same design parameters selected by the first genetic algorithm to seed or start the new generation. For example, processor 202 may use a family of 5 sets of design parameters selected by the first genetic algorithm to be included in the initial generation. Alternatively, processor 202 may also select the design parameters randomly or upon inputs from the user of computer system 200.

Processor 202 may simulate process model 110 with the selected design parameters (step 412). Because process model 110 may be a model of design model 108, the simulations of process model 110 may be similar to that of design model 108. However, because the simulation time on process model 110 may be significantly less than that on design model 108, several generations of simulation may be performed on process model 110 during a single generation of simulation performed on design model 108.

After each generation or iteration of simulation using the selected generation of design parameters (step 412), processor 202 may select the fittest sets of design parameters (step 414). That is, processor 202 may select a number of those parameters corresponding to sets of values of output parameters 106 (e.g., engine power, emission level, etc.) that are closest to desired values (e.g., a maximum engine power with a minimum emission level, etc.). Further, processor 202 may determine whether the first genetic algorithm has completed the current generation that has seeded the initial generation of design parameters of the second genetic algorithm (step 416).

If the first genetic algorithm has not completed the current generation of simulation (step 416; no), processor 202 may continue the optimization process (of the second genetic algorithm) by generating a next generation of design parameters based on the fittest sets of design parameters using various genetic algorithm techniques from step 410, such as tournament selection, mutation, etc., until the completion of the current generation of the first genetic algorithm.

On the other hand, if the first genetic algorithm has completed the current generation of simulation (step 416; yes), processor 202 may provide the fittest design parameters from the second genetic algorithm to the first genetic algorithm (step 418). The first genetic algorithm may use the fittest design parameters from the second genetic algorithm and/or a combination of the fittest design parameters from the second genetic algorithm and the fittest design parameters from the first genetic algorithm to select the next generation of design parameters. Because the searching space may be reduced by the second genetic algorithm during the secondary optimization process, the number of generations required to complete the overall optimization process (i.e., the single track optimization process combined with the secondary optimization process) may be reduced.

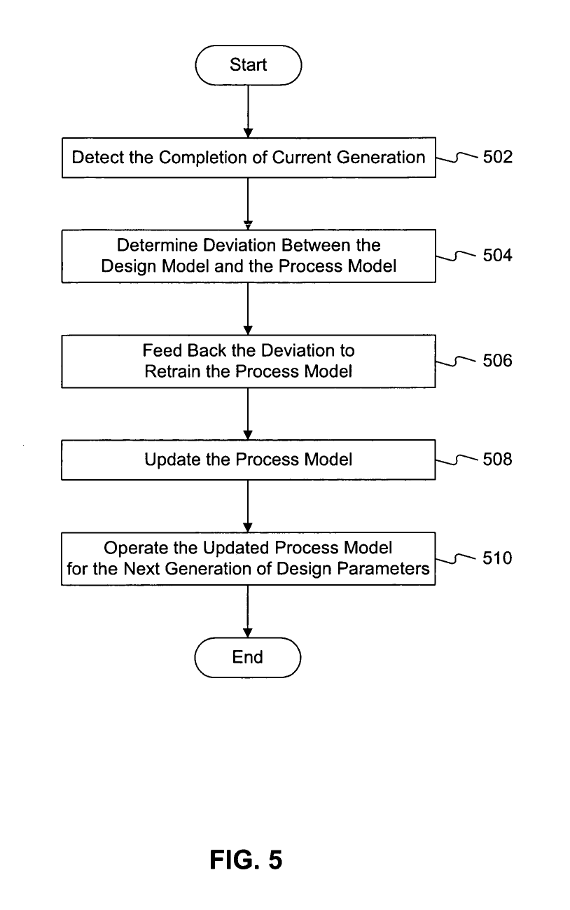

Further, processor 202 may perform a re-training process to improve accuracy of process model 110. FIG. 5 shows an exemplary re-training process performed by processor 202.

As shown in FIG. 5, processor 202 may detect the completion of a current generation of the first genetic algorithm (step 502). Processor 202 may compare values of output parameters 106 of design model 108 and values of output parameters 106 of process model 110 of the same generation to determine deviations between design model 108 and process model 110 (step 504). Processor 202 may further feed back the determined deviation to process model 110 such that process model 110 may be retrained based on the deviation (step 506).

After process model 110 is retrained, processor 202 may update process model (step 508) and use the retrained process model 110 for the next generation of optimization (step 510). The retraining process may be selectively performed after a certain number of generations of simulation or may be performed after every generation of simulation from the first genetic algorithm to improve accuracy of process model 110 and to reduce the total amount of time for searching the optimized design parameters.

### INDUSTRIAL APPLICABILITY

The disclosed systems and methods may provide efficient and effective solutions to reduce the amount of time and/or computation associated with obtaining a global optimum solution for a given search space of a particular design application. Two genetic algorithms may be used separately on different models. The first genetic algorithm may be used with a time consuming design model simulation, while the second genetic algorithm may be used with a fast process model that is modeled based on the design model. The optimized design obtained by the second genetic algorithm from the process model simulation may be used to either reduce the search space of the first genetic algorithm or to provide a better selection source for the first genetic algorithm to create the next generation of design parameters for simulation.

The disclosed systems and methods may also be used to correct real time deviations between the design model and the process model by retraining the process model based on the simulation results of the design model during run time. The process model may then be updated in real time to generate more accurate results.

The disclosed systems and methods may also be integrated into other design environments, such as a CAD environment, so that users of the design environment may use the disclosed systems and methods transparently (i.e., without knowing that the underlying optimization software program is established based the disclosed systems and methods). In different configurations, the disclosed systems and methods may also be used to provide such design optimization software programs to a plurality of design environments concurrently by, for example, using a centralized server connected to a computer network and incorporating the disclosed systems.

The disclosed systems and methods may also provide a smart mutation technique for various genetic algorithm approaches. The second genetic algorithm may use the fast process model, such as a neural network model, to introduce more fitness and/or variability into the first genetic algorithm (e.g., mutation) to reduce the total iteration number required for the first genetic algorithm. The same technique may also be used in other genetic algorithm methodologies.

Other embodiments, features, aspects, and principles of the disclosed exemplary systems will be apparent to those skilled in the art and may be implemented in various environments and systems.

1. A method for a computer based design system, comprising:
selecting a first plurality of sets of design parameters of a design model representing a design application;
individually simulating the design model for each set of the first plurality of sets of the design parameters to create a respective plurality of sets of output parameters corresponding to the design parameters;
choosing at least one set of the design parameters with a corresponding set of output parameters that satisfy predetermined criteria; and
selecting a second plurality of sets of the design parameters based on the at least one set of the design parameters and a process model established based on the design model,
presenting a final set of design parameters based on the second plurality of sets of the design parameters and the design model.

2. The method according to claim 1, before the step of selecting the first plurality of sets of the design parameters, further including:
determining a valid searchable range for the design parameters of the design model.

3. The method according to claim 1, wherein selecting the first plurality of sets of values includes:
setting up a first genetic algorithm; and
selecting the first plurality of sets of the design parameters via the first genetic algorithm.

4. The method according to claim 3, wherein choosing includes:
determining a fitness for each of the first plurality of sets of the design parameters by the first genetic algorithm using a fitness function; and
choosing at least one set of the design parameters based on the fitness.

5. The method according to claim 4, wherein selecting the second plurality of sets of the design parameters includes:
establishing the process model based on the design model;
setting up a second genetic algorithm;
simulating the process model using the first plurality of sets of the design parameters via the second genetic algorithm to generate at least one set of the design parameters; and
selecting the second plurality of sets of the design parameters via the first genetic algorithm based on the at least one set of the design parameters from the first genetic algorithm and the at least one set of the design parameters from the second genetic algorithm.

6. The method according to claim 1, wherein the design model includes a computational fluid dynamics (CFD) model.

7. A method for a computer-based design system, comprising:
creating a current generation of design parameters of a design model;
simulating the design model by using the current generation of design parameters via a first genetic algorithm to generate a first set of desired design parameters;
establishing a process model based on the design model;
simulating the process model by using the current generation of design parameters via a second genetic algorithm to generate a second set of desired design parameters;
selecting a next generation of design parameters based on the first set of desired design parameters and the second set of desired design parameters; and
presenting a final desired set of design parameters based on the next generation of design parameters.

8. The method according to claim 7, wherein establishing includes:
determining that training data is available from the simulation of the design model;
establishing a neural network mathematic model indicative of interrelationships created by the design model between the design parameters and output parameters; and
training the neural network mathematic model using the training data.

9. The method according to claim 7, wherein simulating the process model includes:
simulating the process model for a plurality of iterations via the second genetic algorithm based on current generation of design parameters;
determining completion of the current generation by the first genetic algorithm; and
selecting the second set of desired design parameters from resulting design parameters of the plurality of iterations of simulation.

10. The method according to claim 7, further including:
replacing the current generation of design parameters with the next generation of design parameters; and
simulating both the design model and the process model based on the current generation of design parameters such that the final desired set of parameters is identified by the first genetic algorithm.

11. The method according to claim 7, further including:
simulating the design model based on the next generation of design parameters via the first genetic algorithm; and
retraining the process model based on simulation of the design model based on the next generation of design parameters.

12. The method according to claim 7, wherein selecting the next generation of design parameters is performed by the first genetic algorithm using a mutation technique of genetic algorithm.

13. A computer system, comprising:
a database containing data records associating a design application represented by a design model; and
a processor configured to:
create a current generation of design parameters of the design model;
simulate the design model by using the current generation of design parameters via a first genetic algorithm to generate a first set of desired design parameters;
establish a process model based on the design model;
simulate the process model by using the current generation of design parameters via a second genetic algorithm to generate a second set of desired design parameters;
select a next generation of design parameters based on the first set of desired design parameters and the second set of desired design parameters; and
present a final desired set of design parameters based on the next generation of design parameters

14. The computer system according to claim 13, wherein, to establish the process model, the processor is further configured to:
determine that training data is available from the simulation of the design model;
establish a neural network mathematic model indicative of interrelationships created by the design model between the design parameters and output parameters; and
train the neural network mathematic model using the training data.

15. The computer system according to claim 13, wherein, to simulate the process model, the processor is further configured to:
simulate the process model for a plurality of iterations via the second genetic algorithm based on current generation of design parameters;
determine completion of the current generation by the first genetic algorithm; and
select the second set of desired design parameters from resulting design parameters of the plurality of iterations of simulation.

16. The computer system according to claim 13, wherein the processor is further configured to:
replace the current generation of design parameters with the next generation of design parameters; and
simulate both the design model and the process model based on the current generation of design parameters such that the final desired set of parameters is identified by the first genetic algorithm.

17. The computer system according to claim 13, wherein the processor is further configured to:
simulate the design model based on the next generation of design parameters via the first genetic algorithm; and
retrain the process model based on simulation of the design model based on the next generation of design parameters.

18. A computer-readable medium for use on a computer system configured to perform a design optimization procedure, the computer-readable medium having computer-executable instructions for performing a method comprising:
creating a current generation of design parameters of a design model;
simulating the design model by using the current generation of design parameters via a first genetic algorithm to generate a first set of desired design parameters;
establishing a process model based on the design model;
simulating the process model by using the current generation of design parameters via a second genetic algorithm to generate a second set of desired design parameters;
selecting a next generation of design parameters based on the first set of desired design parameters and the second set of desired design parameters; and
presenting a final desired set of design parameters based on the next generation of design parameters

19. The computer-readable medium according to claim 18, wherein the method further includes:
determining that training data is available from the simulation of the design model;
establishing a neural network mathematic model indicative of interrelationships created by the design model between the design parameters and output parameters; and
training the neural network mathematic model using the training data.

20. The computer-readable medium according to claim 18, wherein the method further includes:
simulating the process model for a plurality of iterations via the second genetic algorithm based on current generation of design parameters;
determining completion of the current generation by the first genetic algorithm; and
selecting the second set of desired design parameters from resulting design parameters of the plurality of iterations of simulation.

21. The computer-readable medium according to claim 18, wherein the method further includes:
replacing the current generation of design parameters with the next generation of design parameters; and
simulating both the design model and the process model based on the current generation of design parameters such that the final desired set of parameters is identified by the first genetic algorithm.

22. The computer-readable medium according to claim 18, wherein the method further includes:
simulating the design model based on the next generation of design parameters via the first genetic algorithm; and
retraining the process model based on simulation of the design model based on the next generation of design parameters.
